(19) United States
(12) Patent Application Publication
(10) Pub. No.: US 2024/0071399 A1
(43) Pub. Date: Feb. 29, 2024

(54) SECURE AUDIO TRANSMISSION EQUALIZATION USING UNIQUE IDENTIFIERS

(71) Applicant: LISNR, INC, Cincinnati, OH (US)

(72) Inventor: Oz MENDEL, Piedmont, CA (US)

(21) Appl. No.: 18/239,382

(22) Filed: Aug. 29, 2023

Related U.S. Application Data
(60) Provisional application No. 63/401,818, filed on Aug. 29, 2022.

(51) Int. Cl. G10L 19/16; G10L 19/005; G10L 19/018

(52) U.S. Cl. CPC G10L 19/167; G10L 19/005; G10L 19/018

(57) ABSTRACT

Methods and systems for improved data communication using audio transmissions are provided. In one embodiment, a method is provided that includes receiving data for transmission and a corresponding identifier. The data may be encoded to form a payload and the identifier may be encoded to form a training sequence. The training sequence may be combined with the payload to form an audio transmission, which may be transmitted as an audio signal within an audio environment.

### CROSS REFERENCE TO RELATED APPLICATIONS

The present application claims priority to U.S. Provisional Application 63/401,818 filed Aug. 29, 2022, which is incorporated herein by reference.

### BACKGROUND

Data often needs to be transmitted between computing devices without connecting both devices to the same computing network. For example, in certain applications, a computing network may not exist near the computing devices, or it may be too cumbersome (e.g., may take too long) to connect one or both of the computing devices to a nearby computing network. Therefore, data may be transmitted directly from one computing device to another.

In some instances, it may be desirable to transmit data between computing devices without connecting both devices to the same computing network to enable identification of a person, or group of persons, located in particular proximity to one or more of the devices.

### SUMMARY

The present disclosure presents new and innovative systems and methods for using unique identifiers to secure audio transmissions. In some aspects, the techniques described herein relate to a method including: receiving data for transmission and an identifier corresponding to the data; encoding the data to form a payload; encoding the identifier to form a training sequence; combining the training sequence and the payload to form an audio transmission; and transmitting the audio transmission as an audio signal within an audio environment.

In some aspects, the techniques described herein relate to a method, further including, prior to encoding the identifier, creating a header that contains the training sequence and header information, and wherein encoding the identifier includes encoding the header.

In some aspects, the techniques described herein relate to a method, wherein the header further includes an error correction code for the training sequence and the header information.

In some aspects, the techniques described herein relate to a method, wherein the header is encoded such that properly decoding the payload requires the identifier.

In some aspects, the techniques described herein relate to a method, wherein the header information includes payload information necessary to accurately decode portions of the audio signal containing the payload.

In some aspects, the techniques described herein relate to a method, wherein the header information includes a payload length for the payload within the audio transmission.

In some aspects, the techniques described herein relate to a method, wherein the training sequence is used by a receiving computing device to equalize a received audio transmission to identify and extract data contained in the payload.

In some aspects, the techniques described herein relate to a method, wherein the training sequence identifies the audio transmission within an audio environment.

In some aspects, the techniques described herein relate to a method, wherein at least one of the data and the identifier are encoded with a predetermined code.

In some aspects, the techniques described herein relate to a method, wherein the predetermined code is a convolution code.

In some aspects, the techniques described herein relate to a method, wherein the predetermined code is a 2/3 convolution code.

In some aspects, the techniques described herein relate to a method, wherein encoding the data includes determining an error correction code for the data, and wherein both the data and the error correction code are encoded.

In some aspects, the techniques described herein relate to a method, wherein the data corresponds to a request transmitted from a computing device over a network connection to a server, and wherein the server responds to the request with the identifier.

In some aspects, the techniques described herein relate to a method, wherein the request includes at least one of a service request and/or a request to process a financial transaction.

In some aspects, the techniques described herein relate to a method including: detecting an audio transmission within a received audio signal; identifying a received training sequence within the audio transmission; equalizing the audio transmission based on the received training sequence and a predetermined identifier to form an equalized audio transmission; decoding at least a first portion of the received training sequence; and decoding a payload of the audio transmission based on the decoded first portion.

In some aspects, the techniques described herein relate to a method, wherein equalizing the audio transmission includes: generating an expected training sequence based on the predetermined identifier; comparing the expected training sequence to the received training sequence; and equalizing the audio transmission based on differences between symbols of the expected training sequence and the received training sequence.

In some aspects, the techniques described herein relate to a method, wherein generating the expected training sequence includes encoding the predetermined identifier according to a predetermined code and extracting a portion of the encoded predetermined identifier.

In some aspects, the techniques described herein relate to a method, wherein generating the expected training sequence includes encoding the predetermined identifier according to a predetermined code and extracting a portion of the encoded predetermined identifier.

In some aspects, the techniques described herein relate to a method, further including generating an audio signal based on the extracted portion of the encoded predetermined identifier to serve as the expected training sequence.

In some aspects, the techniques described herein relate to a method, wherein the differences include one or more of differences in magnitude, differences in phase, and/or differences in frequency for corresponding symbols within the expected training sequence and the received training sequence.

In some aspects, the techniques described herein relate to a method, wherein decoding the first portion of the received training sequence includes decoding a header of the audio transmission that contains the received training sequence.

In some aspects, the techniques described herein relate to a method, wherein decoding the payload of the audio transmission includes: extracting a payload length from the header; and decoding the payload based on the payload length.

In some aspects, the techniques described herein relate to a method, wherein the header further contains an error correction code, and wherein the method further includes: replacing at least a portion of the decoded header with the predetermined identifier to form an updated header; and performing error correction of the updated header based on the error correction code.

In some aspects, the techniques described herein relate to a method, wherein the method further includes: determining that the error correction succeeded; and decoding the payload of the audio transmission based on determining that the error correction succeeded.

In some aspects, the techniques described herein relate to a method, wherein the predetermined identifier corresponds to a previously created request for which an audio transmission is expected.

In some aspects, the techniques described herein relate to a system including a processor and a memory storing instructions which, when executed, cause the processor to: detect an audio transmission within a received audio signal; identify a received training sequence within the audio transmission; equalize the audio transmission based on the received training sequence and a predetermined identifier to form an equalized audio transmission; decode at least a first portion of the received training sequence; and decode a payload of the audio transmission based on the decoded first portion.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a computing system according to exemplary embodiments of the present disclosure.

FIG. 2 illustrates an audio transmission according to an exemplary embodiment of the present disclosure.

FIG. 3 illustrates a system according to an exemplary embodiment of the present disclosure.

FIGS. 4A-4B illustrates an audio transmission generation operation according to an exemplary embodiment of the present disclosure.

FIGS. 5A-5B illustrates an audio transmission decoding operation according to an exemplary embodiment of the present disclosure.

FIG. 6 illustrates a method for generating an audio transmission according to an exemplary embodiment of the present disclosure.

FIG. 7 illustrates a method for decoding an audio transmission according to an exemplary embodiment of the present disclosure.

FIG. 8 illustrates a computing system, according to an exemplary embodiment of the present disclosure.

### DETAILED DESCRIPTION OF EXAMPLE EMBODIMENTS

Various techniques and systems exist to exchange data between computing devices without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency Identification (RFID), Near Field Communication (NFC), and Wi-Fi® (e.g., direct Wi-Fi links between the computing devices). However, each of these protocols relies on data transmission using electromagnetic waves at various frequencies. Therefore, in certain instances (e.g., ZigBee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired to transmit data according to these wireless communication protocols. Such communicative pairing can be cumbersome and slow, reducing the likelihood that users associated with one or both of the computing devices will utilize the protocols to transmit data.

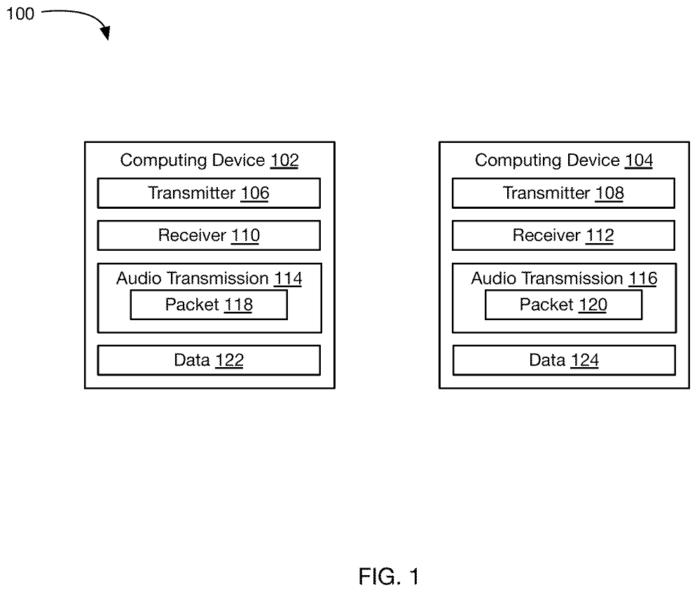

Therefore, there exists a need to wirelessly transmit data in a way that (i) does not require specialized hardware and (ii) does not require communicative pairing prior to data transmission. One solution to this problem is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 may include any type of device capable of generating audio signals, such as speakers. In certain implementations, the transmitters 106, 108 may be implemented as a speaker built into the computing devices 102, 104. For example, one or both of the computing devices may be a smart phone, tablet computer, and/or laptop with a built-in speaker that performs the functions of the transmitters 106, 108. In other implementations, the transmitters 106, 108 may be implemented as a microphone external to the computing device 102, 104. For example, the transmitters 106, 108 may be implemented as one or more speakers externally connected to the computing devices 102, 104.

The receivers 110, 112 may include any type of device capable of receiving audio transmissions and converting the audio transmissions into signals (e.g., digital signals) capable of being processed by a processor of the computing device, such as microphones. In other implementations, the receivers 110, 112 may be implemented as a microphone built into the computing devices 102, 104. For example, one or both of the computing devices may be a smart phone, tablet computer, and/or laptop with a built-in microphone that performs the functions of the receivers 110, 112. In other implementations, the receivers 110, 112 may be implemented as a microphone external to the computing device 102, 104. For example, the receivers 110, 112 may be implemented as one or more microphones external to the computing devices 102, 104 that are communicatively coupled to the computing devices 102, 104. In certain implementations, the transmitters 106, 108 and receivers 110, 112 may be implemented as a single device connected to the computing device. For example, the transmitters 106, 108 and receivers 110, 112 may be implemented as a single device containing both a speaker and a microphone that is communicatively coupled to the computing devices 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112). In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing devices 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmissions 114, 116, the computing devices 102, 104 may modulate the packets 118, 120 onto an audio carrier signal. The computing devices 102, 104 may then transmit the audio transmission 114, 116 via the transmitters 106, 108, which may then be received by the receivers 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 do not require specialized hardware to transmit the data 122, 124.

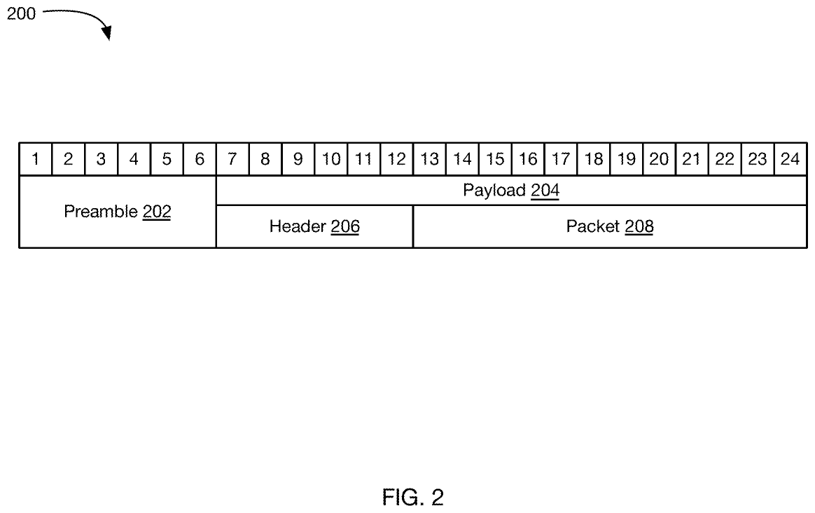

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 5 ms of the audio transmission 200. In other examples, the symbols 1-24 may correspond to other time periods within the audio transmission 200 (e.g., 1 ms, 10 ms, 20 ms, 40 ms). Each symbol 1-24 may include one or more frequencies used to encode information within the audio transmission 200. For example, the one or more frequencies may be modulated to encode information in the audio transmission 200 (e.g., certain frequencies may correspond to certain pieces of information). In another example, the phases of the frequencies may be additionally or alternatively be modulated to encode information in the audio transmission 200 (e.g., certain phase differences from a reference signal may correspond to certain pieces of information).

In particular, certain symbols 1-24 may correspond to particular types of information within the audio transmission 200. For example, the symbols 1-6 may correspond to a preamble 202 and symbols 7-24 may correspond to a payload 204. The preamble 202 may contain predetermined frequencies produced at predetermined points of time (e.g., according to a frequency pattern). In certain implementations, the preamble 202 may additionally or alternatively contain frequencies (e.g., a particular predetermined frequency) whose phase differences are altered by predetermined amounts at predetermined points of time (e.g., according to a phase difference pattern). The preamble 202 may be used to identify the audio transmission 200 to a computing device receiving the audio transmission 200. For example, a receiver of the computing device receiving audio transmissions, such as the audio transmission 200, may also receive other types of audio data (e.g., audio data from environmental noises and/or audio interference). The preamble 202 may therefore be configured to identify audio data corresponding to the audio transmission 200 when received by the receiver of the computing device. In particular, the computing device may be configured to analyze incoming audio data from the receiver and to disregard audio data that does not include the preamble 202. Upon detecting the preamble 202, the computing device may begin receiving and processing the audio transmission 200. The preamble may also be used to align processing of the audio transmission 200 with the symbols 1-24 of the audio transmission 200. In particular, by indicating the beginning of the audio transmission 200, the preamble 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packets 208 may contain data desired for transmission by the computing device generating the audio transmission 200. For example, and referring to FIG. 1, the packet 208 may correspond to the packets 118, 120, which may contain all or part of the data 122, 124. The header 206 may include additional information for relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

The preamble 202 and the payload 204 may be modulated to form the audio transmission 200 using similar encoding strategies (e.g., similar encoding frequencies). Accordingly, the preamble 202 and the payload 204 may be susceptible to similar types of interference (e.g., similar types of frequency-dependent attenuation and/or similar types of frequency-dependent delays). Proper extraction of the payload 204 from the audio transmission 200 may rely on proper demodulation of the payload 204 from an audio carrier signal. Therefore, to accurately receive the payload 204, the computing device receiving the audio transmission 200 must account for the interference.

Symbols 1-24 and their configuration depicted in FIG. 2 are merely exemplary. It should be understood that certain implementations of the audio transmission 200 may use more or fewer symbols, and that one or more of the preamble 202, the payload 204, the header 206, and/or the packet 208 may use more or fewer symbols than those depicted and may be arranged in a different order or configuration within the audio transmission 200.

Audio transmissions may be particularly useful in applications where users need to verify their proximity. For example, audio transmissions may be used to verify when a user has arrived at a location associated with a particular service (e.g., to pick up an order, to enter a premises, to begin or end a rideshare ride). However, audio transmissions suffer from various shortcomings due to their reliance on sound waves within an audio environment. In particular, audio transmissions may take longer to transmit the same amount of data than RF-based transmissions. Furthermore, audio transmissions need to contend with greater forms of interference than RF-based transmissions (e.g., environmental interference from other sound sources). Accordingly, audio transmissions typically have reduced transmission bandwidth when compared to RF-based transmissions. Further, because audio transmissions rely on audio signals, the transmissions themselves are publicly accessible (e.g., using microphones on unauthorized devices). Accordingly, proper security protocols and measures need to be in place to ensure that the contents of audio transmissions transmitted within a public environment are only accessible to the parties that the transmissions are intended for.

One solution to both of these problems is to utilize unique identifiers and/or unique keys to secure access to audio transmissions. For example, upon creating a request for a service, a computing device may receive an identifier corresponding to that request. When needed (e.g., when a user arrives at a specified location, when payment is complete, or when otherwise necessary to fulfill the request), the computing device may generate and transmit and audio transmission that is secured by the corresponding identifier. In particular, the computing device may generate a training sequence for the audio transmission based on the identifier. The training sequence may be used by a receiving computing device to equalize an audio signal containing the received audio transmission to enable accurate further processing of the audio transmission. Additionally or alternatively, the training sequence may be used to indicate the presence of the audio transmission within a received audio signal and may be contained within a header and/or a preamble of the audio transmission. The header and a payload of the audio transmission containing data for transmission (e.g., to initiate further processing of the request) may be encoded according to a predetermined code (e.g., a convolution code) and may be combined into the audio transmission, which may be transmitted as an audio signal within an audio environment for receipt by another computing device.

Upon receiving the audio transmission, a receiving computing device may generate an expected training sequence for the audio transmission. In particular, the computing device may have previously received the identifier used to generate the training sequence and may generate the expected training sequence based on the received identifier. This expected training sequence may then be used to equalize the received audio transmission within an audio signal received from an audio environment surrounding the receiving computing device. The equalized audio transmission may then be processed to extract the payload and data contained within. In particular, without having the identifier used to generate the training sequence, the computing device may be unable to generate the correct expected training sequence and may thus be unable to equalize and properly process the received audio transmission. Furthermore, the audio transmission may be generated to contain various error checking codes. Accordingly, an accurate copy of the identifier may be necessary to properly perform error detection and correction within the received audio transmission and/or the equalized audio transmission.

These techniques simultaneously ensure that a receiving computing device is able to accurately detect when the received audio transmission contains a predetermined identifier. Furthermore, this identifier secures the contents of the audio transmission by being necessary for both the equalization and error correction operations. Furthermore, the header may contain additional information, secured by the identifier, that is necessary to properly decode the payload of the audio transmission (e.g., payload length). Importantly, these operations (and the inclusion of the identifier) are performed without utilizing additional bandwidth within the audio transmission, as training sequences may be necessary regardless of whether an audio transmission contains or requires the unique identifier.

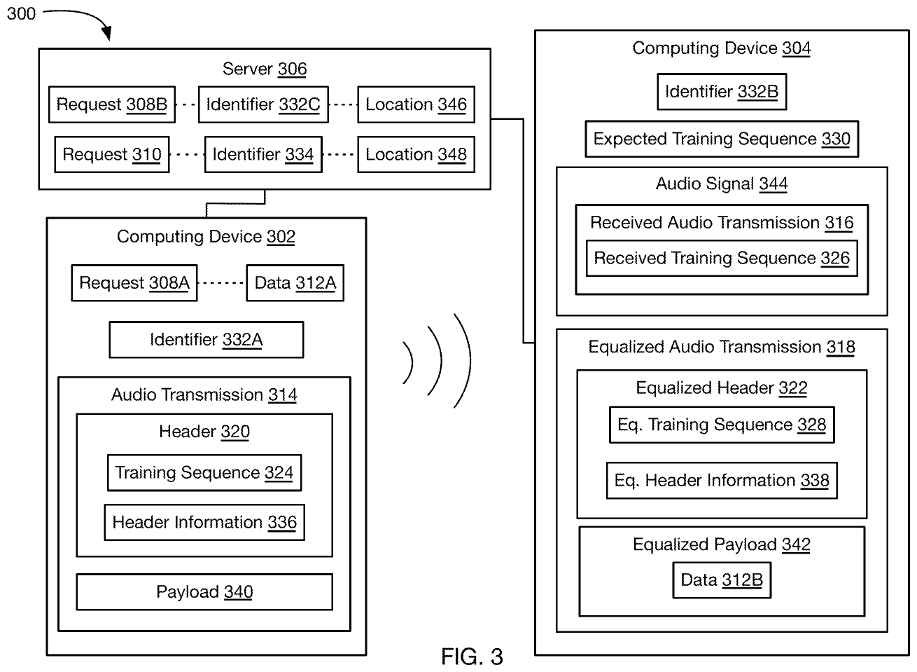

FIG. 3 illustrates a system 300 according to an exemplary embodiment of the present disclosure. The system 300 may be configured to generate and transmit audio transmissions between multiple computing devices within an audio environment. An audio environment may include a physical space containing one or more computing devices capable of receiving and/or transmitting data using audio transmissions. The audio environment may include the physical space in which audio transmissions can be transmitted or received and may include one or more sources of audio interference (e.g., individuals, other computing devices, mechanical devices, electrical devices, speakers, and the like). In particular, the system 300 includes a computing device 302 that may be configured to generate and transmit and audio transmission 314 to another computing device 304 located within an audio environment containing both the computing devices 302, 304, but not necessarily containing the server 306. In practice, these rules may be reversed. In particular, one or both of the computing devices 302, 304 may be configured to both send and receive audio transmissions. In particular, the system 300 may be configured to generate and transmit audio transmissions that are secured using training sequence is generated based on one or more unique identifiers.

The computing device 302 includes a request 308A and data 312A. The request 308A may be a request for a service. The service may include a request to perform a computing service, a location-based service, and/or a financial service. Computing services may include one or more of generating, storing, retrieving, and/or manipulating data (e.g., data associated with a user of the computing device 302). Location-based services may include one or more services in which the user is required to be in a particular location to complete the service (e.g., rideshare services, order pickup and/or delivery services, dog walking services, home cleaning services). Financial services may include creating an order with a retailer, fulfilling an order with the retailer, creating and/or processing a payment on behalf of a user associated with the computing device 302, and the like. The request 308A may be created by the computing device 302 by a user associated with the computing device 302. Additionally or alternatively, a user associated with the computing device 302 may create the request 308A using another computing device (not depicted). In certain instances, the request 308A may not be created by the user but may be created on the user's behalf (e.g., by another user or individual, by an automated computing service).

The request 308A may be transmitted to the server 306 upon creation. For example, the server 306 may store a copy of the request 308B (equivalent to the request 308A) and other requests 310 in association with corresponding identifiers 332C, 334 and, in certain implementations associated locations 346, 348. In particular, the server 306 may receive the request 308B and, in response, may create and store the associated identifier 332C and may transmit a copy of the identifier 332C to the computing device 302 (received as identifier 332A, which is equivalent to the identifier 332C). A copy of the identifier 332C may also be transmitted to the computing device 304 (received as the identifier 332B). In particular, the server 306 may identify a computing device 304 associated with the request 308B and may transmit a copy of the identifier 332C to the identified computing device 304. In one example, where the request 308B corresponds to a location-based service, the server 306 may identify the computing device 304 as a computing device located at, near, or within a location 346 corresponding to the request 308B communication between the computing device 302 and the server 306 and between the computing device 304 and the server 306 may occur via a network interface (e.g., via a wired or wireless network interface).

The computing device 302 may be configured to generate and transmit and audio transmission 314 that is secured based at least in part on the identifier 332A received from the server 306. For example, the computing device 302 may be configured to generate the audio transmission 314 to trigger further processing of the request 308A. For example, upon arriving at the location 346 (e.g., a retail location) for a location-based service (e.g., to pick up an order for goods purchased online via a retailer), the computing device 302 may be configured to generate and/or transmit the audio transmission 314 for receipt by the computing device 304. In certain instances, the computing device 302 may be configured to generate the audio transmission 314 immediately prior to transmitting the audio transmission 314. In additional or alternative implementations, the computing device 302 may generate the audio transmission 314 well before (e.g., minutes, hours, days, weeks before) transmitting the audio transmission 314. For example, a user may submit the request 308A while at home to a retailer's online portal and, in response, the computing device 302 may receive the identifier 332A. The computing device 302 may, in certain implementations, generate the audio transmission 314 upon receiving the identifier 332A. The user may travel to the retail location several hours and/or several days later, and the computing device 302 may transmit the audio transmission 314 upon arriving at the location 346 of the retail location to pick up the order.

The audio transmission 314 may be generated to indicate the computing device's 302 presence near the computing device 304 (e.g., within a transmission range of audio transmissions, such as within 100 feet, within 200 feet, and/or within 500 feet depending on the implementation). Furthermore, the computing device 302 may generate the audio transmission 314 to include a payload 340 that contains the data 312A. The data 312A may include additional information necessary to process or continue processing the request 308A. In one example, the request 308A may be to pick up an order from a retail location, and the data 312A may include payment confirmation information (e.g., from a payment processing service to indicate and verify that the user has paid for the goods that are being picked up, to identify an order for which the user is picking goods up). To secure the contents of the audio transmission 314 (e.g., contents of the payload, contents of a header 320 of the audio transmission 314), the audio transmission 314 may be secured and/or encoded based on the identifier 332A. In particular, the computing device 302 may generate a training sequence 324 based on the identifier 332A. The training sequence 324 may be used to equalize and/or adjust an audio signal containing the audio transmission 314 when received by another computing device, such as the computing device 304. In particular, the training sequence 324 may be used to correct for various types of interference, which may cause changes to audio characteristics of the audio transmission 314 when received (e.g., changes in magnitude, frequency, and/or phase for one or more symbols of the audio transmission 314. To properly equalize the audio transmission, it may be necessary for a receiving computing device to contain a copy of the identifier 332A used to create the training sequence 324, as explained further below. In additional or alternative implementations, the training sequence 324 may additionally be used to indicate the presence of the audio transmission 314 within an audio signal 344. Accordingly, it may be necessary to know the identifier 332A to properly detect the audio transmission 314 within a surrounding audio environment. After generating the audio transmission 314, the computing device 304 may transmit the audio transmission 314 using one or more audio transmitters (e.g., one or more speakers contained within and/or communicatively coupled to the computing device 302).

The computing device 304 may be configured to monitor a surrounding audio environment using one or more audio receivers (e.g., microphones) contained within and/or communicatively coupled to the computing device 304. In particular, the computing device 304 may continually receive and monitor incoming audio signals 344 for the presence of audio transmissions. As explained above, the computing device 304 may have previously received a copy of the identifier 332B from the server 306. Upon detecting a received audio transmission 316 within an audio signal 344 received from the surrounding audio environment, the computing device 304 may be configured to equalize and decode the received audio transmission 316 to extract data contained within a payload of the received audio transmission 316.

In particular, the computing device 304 may generate an expected training sequence 330 based on the identifier 332B. As explained further below, the expected training sequence 330 may be generated by encoding the expected training sequence 330 according to a predetermined code (e.g., a predetermined convolution code). The encoded identifier may then be converted into an audio signal for use as the expected training sequence 330. To equalize the received audio transmission 316, the computing device 304 may compare a received training sequence 326 extracted from a corresponding portion of the audio signal 344 to the expected training sequence 330. The computing device 304 may identify one or more differences between the expected training sequence 330 and the received training sequence 326 (e.g., differences in magnitude, phase, and/or frequency) and may generate and apply one or more adjustments to the received audio transmission 316 (e.g., a portion of the audio signal 344 containing the received audio transmission 316) to generate the equalized audio transmission 318. Specific techniques for equalizing audio transmissions are discussed in greater detail in U.S. patent application Ser. Nos. 17/756,348 and 17/756,351, which are incorporated herein by reference for all purposes.

The computing device 304 may then process the equalized transmission 318 to extract the data 312B (which may be identical to the data 312) contained within an equalized payload 342 and/or equalized header information 338 contained within equalized header 322 of the equalized audio transmission 318. For example, and as discussed further below, the equalized header 322 may be decoded according to a predetermined code (e.g., a predetermined convolution code), and error correction may be performed based on the decoded contents of the equalized header 322 based on one or more of the equalized training sequence 328 and/or the identifier 332B. If the computing device 304 does not have a copy of the identifier 332B, the computing device 304 may not be able to perform proper error correction for the equalized header 322 and, by extension, the equalized header information 338. The equalized payload 342 may be similarly decoded according to a predetermined code. In certain instances, at least a portion of the equalized header information 338 may be necessary to properly decode the equalized payload 342. For example, the equalized header information 338 may contain a payload length identifying a length (e.g., in symbols of the audio transmission, in total bits) of the equalized payload 342, which may be necessary to properly apply the predetermined code (e.g., the predetermined convolution code). Once properly decoded, the computing device 304 may extract the data 312B and continue processing according to the request 308A (e.g., processing a payment on behalf of the user, opening a locker so the user can retrieve their purchased goods, transmitting a notification to retail employees to deliver the goods). Accordingly, the computing device 304 is able to detect and securely decode the audio transmission 314 without requiring additional transmission bandwidth for the identifier 332A-B and without sacrificing the accuracy gains enabled by including a training sequence and equalizing received audio transmissions according to predetermined training sequences.

The computing devices 302, 304 and/or the server 306 may also include a processor and a memory (not depicted). The processor and the memory may implement one or more aspects of the computing devices 302, 304 and/or the server 306. For example, the memory may store instructions which, when executed by the processor, may cause the processor to perform one or more operational features of the computing devices 302, 304 and/or the server 306. The processor may be implemented as one or more central processing units (CPUs), field programmable gate arrays (FPGAs), and/or graphics processing units (GPUs) configured to execute instructions stored on the memory. Additionally, the computing devices 302, 304 and/or the server 306 may be configured to communicate using a network. In particular, the computing device 302 may be configured to communicate with the server 306 via a network, and/or the computing device 304 may be configured to communicate with the server 306 via a network. The computing devices 302, 304 and/or the server 306 may communicate with the network using one or more wired network interfaces (e.g., Ethernet interfaces) and/or wireless network interfaces (e.g., Wi-Fi®, Bluetooth®, and/or cellular data interfaces). In certain instances, the network may be implemented as a local network (e.g., a local area network), a virtual private network, L1, and/or a global network (e.g., the Internet).

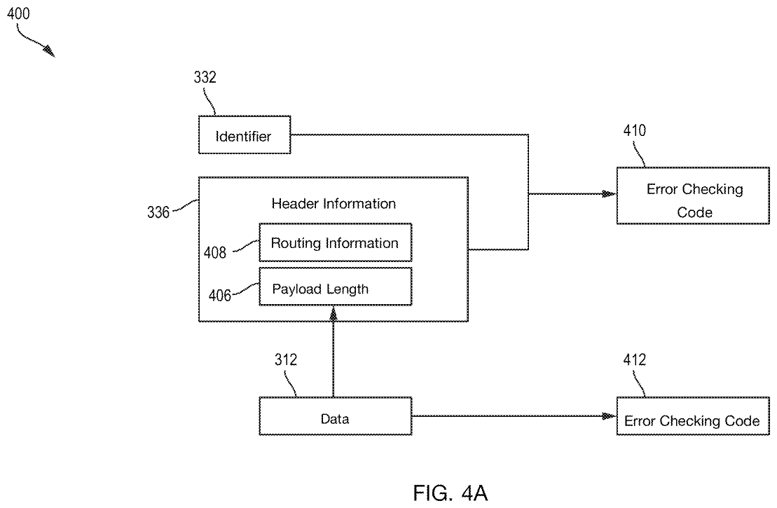

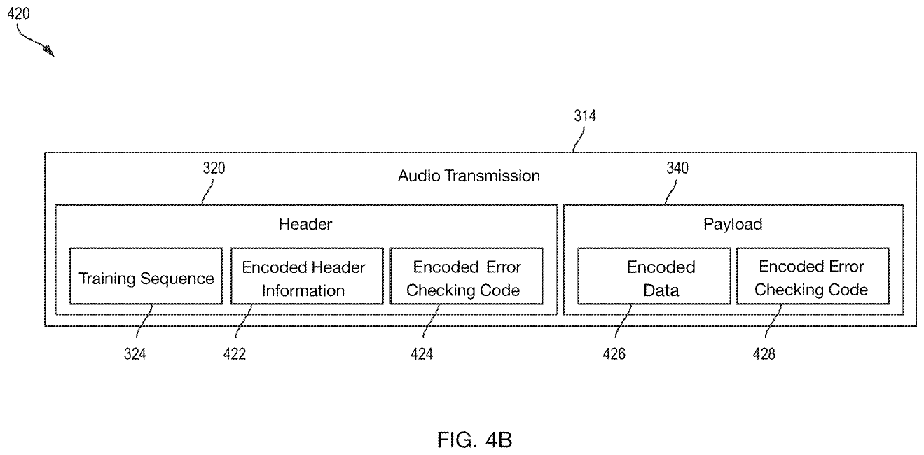

FIGS. 4A-4B illustrate audio transmission generation operations 400, 420 according to an exemplary embodiment of the present disclosure. For example, the operations 400, 420 may be performed to generate the audio transmission 314 by the computing device 302. Starting with FIG. 4A, in the operation 400, the computing device 302 may receive the identifier 332 and may receive and/or generate the data 312. The computing device 302 may generate header information 336 for the audio transmission 314. In particular, the computing device 302 may determine a payload length 406 for the data 312. The payload length 406 may differ based on the size of the data 312 and the encoding techniques used to encode the data 312 within one or more audio symbols. The computing device 302 may also determine routing information 408 to be included in the header information 336. For example, the routing information 408 may specify a final destination for the data 312 (e.g., a computing device ultimately intended to receive the data 312, an API endpoint for the data 312, a corresponding entity intended to receive the data 312). The computing device 302 may, in certain implementations, add additional or alternative information to the header information 336 beyond the routing information 408 and the payload length 406. Furthermore, in various implementations, the header information 336 may exclude one or both of the routing information 408 and the payload length 406. After generating the header information 336, the computing device 302 may generate an error checking code 410 based on the identifier 332 and the header information 336. The error checking code 410 may be generated according to various error detection and/or correction protocols. For example, the error checking code 410 may be generated based on one or more of a checksum protocol, a cyclic redundancy check (CRC) protocol, an automatic repeat request protocol, a forward error correction protocol, and the like, or any combination of multiple error detection and correction protocols. In particular, the error checking code 410 may be generated as a CRC error checking and correction code for the combined identifier 332 and header information 336. The computing device 302 may similarly generate an error checking code 412 based on the data 312.

Turning to FIG. 4B, in the operation 420, the computing device 302 may encode one or more of the identifier 332, the header information 336, the error checking code 410, the data 312, and the error checking code 412 to generate, respectively, the training sequence 324, the encoded header information 422, the encoded error checking code 424, the encoded data 426, and/or the encoded error checking code 428. The encoding may be performed according to one or more predetermined encoding and/or encryption protocols. For example, the identifier 332, the header information 336, the error checking code 410, the data 312, and/or the error checking code 412 may be encoded according to a convolution encoding protocol. In one particular embodiment, the encoding is performed according to a convolution encoding protocol with a predetermined code (e.g., a 2/3 code). In additional or alternative implementations, the encoding protocol may include one or more of a low-density parity-check encoding protocol and/or a turbo or twin-turbo encoding protocol. In certain implementations, the identifier 332, the header information 336, and the error checking code 410 may be appended sequentially together and encoded as a single unit. Similarly, the data 312 and the error checking code 412 may be appended sequentially together and encoded as a single unit. In additional or alternative implementations, one or more of the identifier 332, the header information 336, the error checking code 410, the data 312, and/or the error checking code 412 may be individually encoded. The audio transmission 314 may then be formed from the training sequence 324, the encoded header information 422, the encoded error checking code 424, the encoded data 426, and the encoded error checking code 428. For example, the header 320 may be generated to include the training sequence 324, the encoded header information 422, and the encoded error checking code 424. In certain instances, the header 320 may be an example implementation of the preamble 202 of an audio transmission. The payload 340 may be formed by combining the encoded data 426 and the encoded error checking code 428. In certain instances, further processing may be performed to generate the audio transmission 314. For example, a Gray code may be applied to the header 320 and/or the payload 340, and the data bits contained within the header 320 and the payload 340 may be modulated onto one or more audio symbols according to a predetermined modulation protocol, such as frequency-shift keying (FSK), amplitude-shift keying (ASK), phase shift keying (PSK), quadrature amplitude modulation (QAM), and the like. In one example, 8PSK is used, where each audio symbol represents 3 bits of information. Prior to transmission, an audio signal based on the modulated audio transmission 314 may be generated and transmitted using a speaker or other audio transmitter of the computing device 302.

In one example implementation, the identifier 332 may be 128 bits long and the header information 336 may be 24 bits long. In such instances, the error checking code 410 may be 16 bits long (e.g., according to a 16-bit CRC error checking and correction protocol). In various implementations, the length of the payload may differ according to how much data needs to be transmitted. However, the error checking code 412 for the payload may be maintained at a constant length (e.g., 16 bits) in certain implementations. In such implementations, an 4PSK modulation protocol may be used to modulate the data onto different audio symbols. In such instances, the resulting audio transmission may include 64 audio symbols for the training sequences 324, 12 audio symbols for the encoded header information 422, 8 audio symbols for the encoded error checking code 424, 8 audio symbols for the encoded error checking code 428, and a variable number of audio symbols for the encoded data 426.

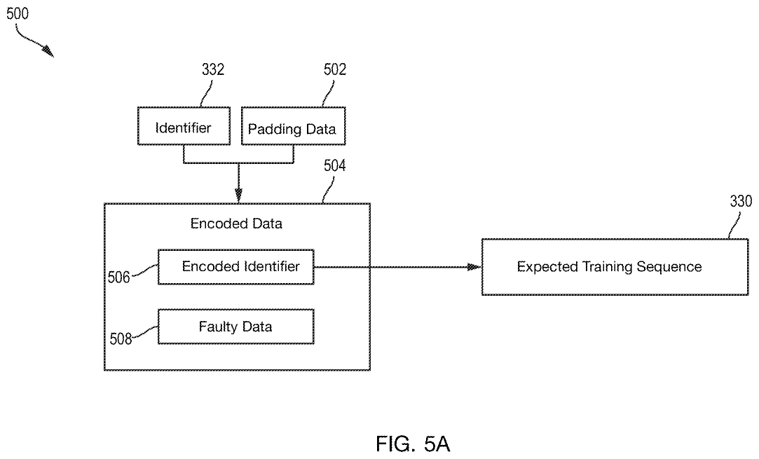

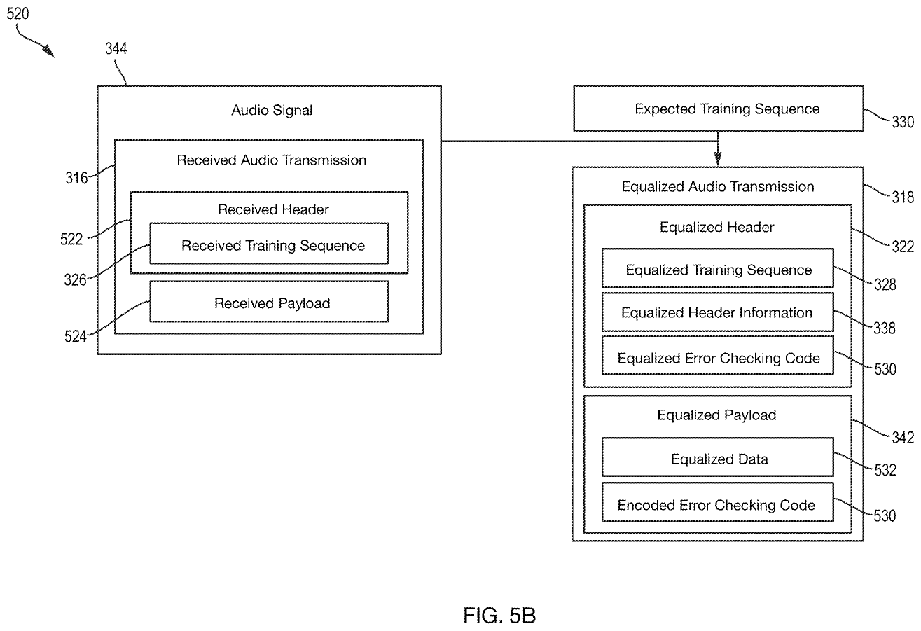

FIGS. 5A-5B illustrate audio transmission decoding operations 500, 520 according to an exemplary embodiment of the present disclosure. For example, the operations 500, 520 may be performed by the computing device 304 to process and decode a received audio transmission 316 detected within audio signals 344 from a surrounding audio environment. Starting with FIG. 5A, in the operation 500, the computing device 304 may receive the identifier 332. The identifier 332 may be combined with padding data 502 and may be encoded with the padding data 502 to generate encoded data 504. The padding data 502 may include a predetermined sequence of data that is appended to the identifier 332 for performing the encoding operation to generate the encoded data 504. In various implementations, the padding data 502 may be 8 bits long and may contain all zero bits. Padding the identifier 332 may be necessary to account for the effects of subsequent bits within the header 320 when the header 320 was encoded (e.g., effects that adjacent bits have on a convolution encoding operation). As a result of performing the encoding operation on the combined identifier 332 and padding data 502, the encoded data 504 includes an encoded identifier 506 along with subsequent faulty data 508. The faulty data may be discarded, and the encoded identifier 506 may be used to generate the expected training sequence 330. In particular, the expected training sequence may be generated by generating an audio signal based on the encoded identifier 506. For example, the encoded identifier 506 may be modulated according to one or more modulation protocols (e.g., as discussed above) to form one or more corresponding audio symbols. Additionally or alternatively, a Gray code may be applied to the encoded identifier 506. Subsequently, an audio signal may be generated based on the modulated audio symbols. Importantly, the expected training sequence 330 may be generated by performing the same processing used to generate an audio signal for the audio transmission 314.

Turning to FIG. 5B, the computing device 304 may detect the received audio transmission 316 within audio signals 344 received from an audio environment surrounding the computing device 304. In certain instances, the audio transmission 316 may be detected based on an audio signal (e.g., an audio signal preceding or contained within the header 522). For example, the header may contain or otherwise be preceded by an audio chirp signal (e.g., an analog audio signal with an ascending or descending frequency). The computing device 304 may detect the received audio transmission by detecting the audio chirp signal. The received audio transmission 316 may include the received header 522 and a received payload 526. The received header 522 may include a received training sequence 326. Various types of audio interference may adversely affect the audio transmission 314 when transmitted between the computing device 302 and the computing device 304. Accordingly, the received audio transmission 316 may differ in one or more ways from the audio transmission 314 as transmitted. It may thus be necessary to equalize the received audio transmission 316 before further processing to ensure that the data is accurately extracted from the received audio transmission 316.

In particular, the computing device 304 may equalize the received audio transmission 316 based on the expected training sequence 330. In particular, the computing device 304 may identify the received training sequence 326 within the received transmission 316. The computing device 304 may compare the received training sequence 326 with the expected training sequence 330 and may identify one or more differences. For example, the computing device 304 may compare corresponding symbols within the received training sequence 326 and the expected training sequence 330. The computing device 304 may identify one or more differences between the corresponding symbols. For example, the symbols may differ in magnitude, phase, and/or frequency. In particular, each of the symbols may have one or more expected, predetermined phases, frequencies, and/or magnitudes, as indicated by the symbols within the expected training sequence 330. Based on these differences, the computing device at 304 may determine one or more adjustments to apply to the audio signal 344 containing the received audio transmission 316. The adjustments may include changing magnitudes and/or phases. In certain implementations, these adjustments may be created and/or may be applied differently for different frequencies and/or for different frequency bands. The adjustments may then be applied to the audio signal 344 (e.g., a portion of the audio signal containing received audio transmission 316) to generate the equalized audio transmission 318. The equalized audio transmission 318 may contain the equalized contents of the received audio transmission 316. In particular, the equalized audio transmission 318 contains an equalized header 322 and an equalized payload 342. The equalized header 322 contains an equalized training sequence 328, an equalized header information 338, and an equalized error checking code 530. The equalized payload 342 contains equalized data 532 and equalized error checking code 530.

To process the equalized audio transmission 318 (e.g., to extract the equalized data 532), the computing device 304 may begin by extracting the equalized header information 338. To extract the equalized header information, the computing device 304 may decode the equalized header 322. For example, the computing device 304 may decode the equalized header 322 according to the predetermined code and/or a predetermined encoding protocol used to encode the header 320 the computing device 302. After decoding the equalized header 322, the computing device 304 may perform error checking and correction on the contents of the decoded header. In particular, the computing device 304 may utilize the equalized error checking code 530 to detect and correct errors within the data contained within one or both of the equalized training sequence 328 and the equalized header information 338. In certain instances, the computing device 304 may replace the decoded training sequence with a copy of the identifier 332. In such instances, if the identifier 332 is not the same as the identifier used to create the training sequence (e.g., and thus present within the decoded training sequence), the error checking and correction may fail, because the error checking code 530 was prepared based on a different identifier. Accordingly, the identifier may be used to secure access to the payload of the audio transmission by preventing proper error correction of the equalized audio transmission 318 without the proper identifier. In particular, if decoding of the equalized header 322 fails, the computing device 304 may terminate further processing of the received audio transmission 316.

After decoding the equalized header 322, the computing device 304 may extract the equalized header information 338 and use all or part of the equalized header information 338 to extract equalized data 532. In particular, the equalized header information 338 may contain a copy of the payload length 406, which may be necessary to properly decode the equalized payload 342. Based on the payload length 406, the computing device 304 may decode the equalized payload 342 (e.g., based on the predetermined code and/or encoding protocol utilized by the computing device at 302 to encode the payload 340). The computing device 304 may then perform error checking and correction on the contents of the equalized payload 342 after decoding based on the equalized error checking code 530 and the predetermined error checking and correction protocol utilized by the computing device 302 to generate the equalized error checking code 530. After correcting any errors, the computing device 304 may then be able to extract a properly decoded and error corrected copy of the data 312.

Accordingly, the computing devices 302, 304 are able to communicate using secured audio transmissions, whose contents are secured by unique identifiers associated with corresponding requests. This both improves security of communication using audio transmissions and does not require the unique identifier to be included within audio transmission payload, which reduces the size of transmitted audio transmissions and accordingly reduces overall bandwidth requirements for audio transmissions that require unique identifiers.

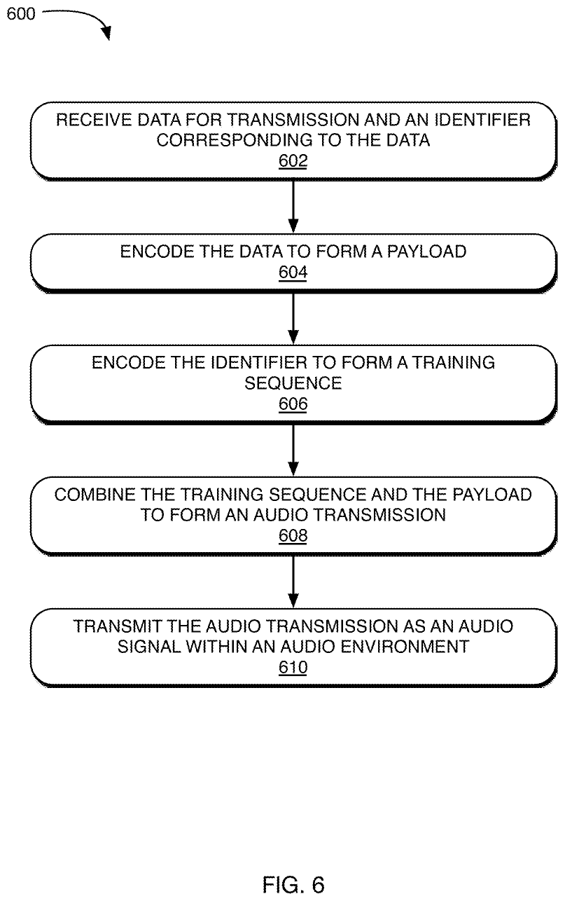

FIG. 6 illustrates a method 600 for generating an audio transmission according to an exemplary embodiment of the present disclosure. The method 600 may be implemented on a computer system, such as the system 300. For example, the method 600 may be implemented by the computing devices 302, 304 and/or the server 306. The method 600 may also be implemented by a set of instructions stored on a computer readable medium that, when executed by a processor, cause the computer system to perform the method 600. Although the examples below are described with reference to the flowchart illustrated in FIG. 6, many other methods of performing the acts associated with FIG. 6 may be used. For example, the order of some of the blocks may be changed, certain blocks may be combined with other blocks, one or more of the blocks may be repeated, and some of the blocks may be optional.

The method 600 may begin with receiving data for transmission and an identifier corresponding to the data (block 602). For example, the computing device 302 may receive data 312A for transmission and an identifier 332A corresponding to the data 312A. For example, the computing device 302 may receive the data 312A as part of creating a request 308A for a service. In particular, the computing device 302 may create the request 308A and the data 312A and may transmit the request 308A to the server 306. In response, the server 306 may generate an identifier 332C corresponding to the request 308B and may transmit the identifier 332C to the computing device 302 (received as the identifier 332A). Communication between the computing device 302 and the server 306 may occur over a network connection, as described above.

The data may be encoded to form a payload (block 604). For example, the computing device 302 may encode the data 312A to form a payload 340 for use within an audio transmission 314. As explained further above, encoding the data 312A may include generating an error checking code 412 for the data 312A and encoding the data 312 and the error checking code 412 to form the payload 340. Accordingly, the payload 340 may include encoded data 426 and an encoded error checking code 428.

The identifier may be encoded to form a training sequence (block 606). For example, the computing device 302 may encode the identifier 332A to form a training sequence 324 for use within the audio transmission 314. As explained above, the training sequence 324 may be used to equalize a received version of the audio transmission 314 and/or to indicate the presence of an audio transmission 314 within audio signals from an audio environment. As explained above, encoding the identifier 332A may include determining an error checking code for the identifier 332 and/or for header information 336 of the audio transmission 314. In various implementations, the identifier 332, header information 336, and/or error checking code 410 may be encoded together to form a header 320 of the audio transmission 314.

The training sequence and the payload may be combined to form an audio transmission (block 608). For example, the computing device 302 may combine the training sequence 324 and the payload 340 to form an audio transmission 314. In implementations where the training sequence 324 is included as part of a header 320 of the audio transmission 314, the header 320 and the payload 340 may be combined to form the audio transmission. Additionally or alternatively, the training sequence 324 may be separate from the header 320 (e.g., may be encoded and/or error checked separate from contents of the header 320). In such instances, the training sequence 324, the payload 340, and the header 320 may be combined to form the audio transmission 314.

The audio transmission may be transmitted as an audio signal within an audio environment (block 610). For example, the computing device 302 may transmit the audio transmission as an audio signal within an audio environment surrounding the computing device 302. In certain instances, the audio environment may contain other computing devices 304 configured to receive audio transmissions. To transmit the audio transmission as an audio signal, the computing device 302 may be configured to convert the digital data within the audio transmission 314 as initially assembled into an analog audio signal. In particular, the data contents of the audio transmission 314 may be modulated onto one or more audio symbols (e.g., combinations of one or more of magnitude, frequency, and phase) according to a predetermined modulation protocol. These audio symbols may then be used to generate an audio signal that can be used to transmit the audio transmission 314 within an audio environment.

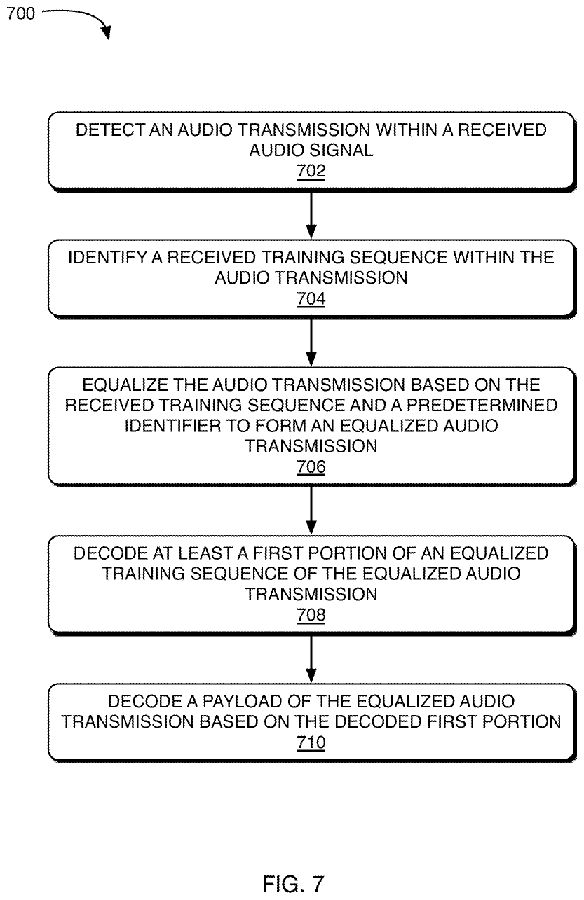

FIG. 7 illustrates a method 700 for decoding an audio transmission according to an exemplary embodiment of the present disclosure. The method 700 may be implemented on a computer system, such as the system 300. For example, the method 700 may be implemented by the computing devices 302, 304 and/or the server 306. The method 700 may also be implemented by a set of instructions stored on a computer readable medium that, when executed by a processor, cause the computer system to perform the method 700. Although the examples below are described with reference to the flowchart illustrated in FIG. 7, many other methods of performing the acts associated with FIG. 7 may be used. For example, the order of some of the blocks may be changed, certain blocks may be combined with other blocks, one or more of the blocks may be repeated, and some of the blocks may be optional.

The method 700 may begin with detecting an audio transmission within a received audio signal (block 702). For example, a computing device 304 may detect an audio transmission 316 within an audio signal 344. The audio signal 344 may be received from an audio environment surrounding the computing device 304. For example, the computing device 304 may include one or more audio receivers configured to continuously receive audio signals 344 from a surrounding audio environment. The computing device 304 may monitor the audio signals 344 captured by the audio receivers for audio transmissions and may detect the received audio transmission 316 within the audio signal 344 (e.g., based on an audio chirp signal and/or another predetermined audio sequence).

A received training sequence may be identified within the audio transmission (block 704). For example, the computing device 704 may identify a received training sequence 326 within the received audio transmission 316. The received training sequence 326 may be identified based on a starting point of the received audio transmission 316 within the audio signal 344. In particular, the received training sequence 326 may occur at a predetermined duration after the beginning of the received audio transmission 316 (e.g., the first 20 milliseconds, from 5 milliseconds to 65 milliseconds after the beginning of the received audio transmission 316). Additionally or alternatively, the computing device 304 may identify the received training sequence 326 based on an expected training sequence 330. For example, the computing device 304 may identify a portion of the audio signal 344 that most closely resembles the expected training sequence 330 as containing the received training sequence 326.

The audio transmission may be equalized based on the received training sequence and a predetermined identifier to form an equalized audio transmission (black 706). For example, the computing device 304 may equalize the received audio transmission 316 based on the received training sequence 326 and the identifier 332B. In certain implementations, the computing device 304 may generate an expected training sequence 330 based on the identifier 332B, as explained above. The expected training sequence 330 may then be compared to the received training sequence 326 to identify one or more differences. One or more corrections may then be applied to the audio signal 344 (e.g., portions of the audio signal 344 containing the received audio transmission 316) based on the differences between the expected training sequence 330 and the received training sequence 326 to form the equalized audio transmission 318.

At least the first portion of an equalized training sequence of the equalized audio transmission may be decoded (block 708). For example, the computing device 304 may decode at least a first portion of an equalized training sequence 328 of the equalized audio transmission 318. In particular, the computing device 304 may decode all or part of the equalized trading sequence 328 according to a predetermined encoding protocol used to encode the training sequence 324 before transmission. In various implementations, the equalized audio transmission 318 may contain an equalized header 322 that itself includes the equalized training sequence 328 and/or additional information (e.g., equalized header information 338 and/or equalized error checking code 530). In certain implementations, the entire equalized header 322 may be decoded together (e.g., according to a predetermined encoding protocol utilized by the computing device 302 to encode the header 320). In various implementations, as described above, after decoding the equalized training sequence 328 and/or the equalized header 322, the computing device 304 may further be configured to perform one or more error checking and correction operations according to a predetermined error detection and correction protocol and the decoded error checking code contained within the equalized header 322. In certain instances, performing the error detection and correction may include replacing a decoded training sequence with the identifier 332B, as described above.

A payload of the equalized audio transmission may be decoded based on the decoded first portion (block 710). For example, the computing device 304 may decode an equalized payload 342 of the equalized audio transmission 318 based on the decoded first portion of the equalized training sequence 328 and/or based, at least in part, on the decoded equalized header 322. For example, the computing device 304 may extract a payload length 406 from the decoder equalized header information 338 and may decode the equalized payload 342 based on the payload length 406 and the predetermined encoding protocol. After decoding the equalized payload 342, the computing device 304 may perform error detection and correction on the data 312B contained within the decoded payload 340 (e.g., based on an error checking code extracted from the payload 340). After detecting and correcting any errors in the data 312B, the computing device 304 may extract the data 312 before further processing (e.g., in connection with one or more services associated with the request 308A for which the audio transmission 314 was transmitted). In particular, the computing device 304 may verify the contents of the data 312B to further process, e.g., a payment associated with the request 308A.

Accordingly, the methods 600, 700 ensure that computing devices are able to communicate with one another using audio transmissions in a manner that is both secure and efficient. In particular, utilizing unique identifiers to secure data payloads of audio transmissions simultaneously improves the security of the audio payloads themselves while also reducing overall audio transmission bandwidth requirements. Furthermore, training sequences generated based on unique identifiers maintain the substantial accuracy improvements enabled by equalizing audio transmissions prior to decoding and further processing of their data contents. The accuracy improvements also reduce overall audio transmission bandwidth requirements, as computing devices that communicate using audio transmissions with training sequences reduce the need to retransmit data when transmission fails.

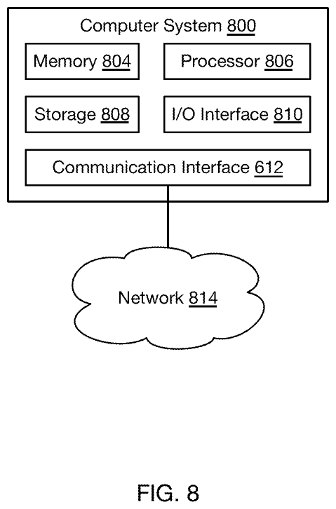

FIG. 8 illustrates an example computer system 800 that may be utilized to implement one or more of the devices and/or components discussed herein, such as the system 300, the computing devices 102, 104, 302, 304, and/or the server 306. In particular embodiments, one or more computer systems 800 perform one or more steps of one or more methods described or illustrated herein. In particular embodiments, one or more computer systems 800 provide the functionalities described or illustrated herein. In particular embodiments, software running on one or more computer systems 800 performs one or more steps of one or more methods described or illustrated herein or provides the functionalities described or illustrated herein. Particular embodiments include one or more portions of one or more computer systems 800. Herein, a reference to a computer system may encompass a computing device, and vice versa, where appropriate. Moreover, a reference to a computer system may encompass one or more computer systems, where appropriate.

This disclosure contemplates any suitable number of computer systems 800. This disclosure contemplates the computer system 800 taking any suitable physical form. As example and not by way of limitation, the computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example, and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 806, memory 804, storage 808, an input/output (I/O) interface 810, and a communication interface 812. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 806 includes hardware for executing instructions, such as those making up a computer program. As an example, and not by way of limitation, to execute instructions, the processor 806 may retrieve (or fetch) the instructions from an internal register, an internal cache, memory 804, or storage 808; decode and execute the instructions; and then write one or more results to an internal register, internal cache, memory 804, or storage 808. In particular embodiments, the processor 806 may include one or more internal caches for data, instructions, or addresses. This disclosure contemplates the processor 806 including any suitable number of any suitable internal caches, where appropriate. As an example, and not by way of limitation, the processor 806 may include one or more instruction caches, one or more data caches, and one or more translation lookaside buffers (TLBs). Instructions in the instruction caches may be copies of instructions in memory 804 or storage 808, and the instruction caches may speed up retrieval of those instructions by the processor 806. Data in the data caches may be copies of data in memory 804 or storage 808 that are to be operated on by computer instructions; the results of previous instructions executed by the processor 806 that are accessible to subsequent instructions or for writing to memory 804 or storage 808; or any other suitable data. The data caches may speed up read or write operations by the processor 806. The TLBs may speed up virtual-address translation for the processor 806. In particular embodiments, processor 806 may include one or more internal registers for data, instructions, or addresses. This disclosure contemplates the processor 806 including any suitable number of any suitable internal registers, where appropriate. Where appropriate, the processor 806 may include one or more arithmetic logic units (ALUs), be a multi-core processor, or include one or more processors 806. Although this disclosure describes and illustrates a particular processor, this disclosure contemplates any suitable processor.

In particular embodiments, the memory 804 includes main memory for storing instructions for the processor 806 to execute or data for processor 806 to operate on. As an example, and not by way of limitation, computer system 800 may load instructions from storage 808, or another source (such as another computer system 800), to the memory 804. The processor 806 may then load the instructions from the memory 804 to an internal register or internal cache. To execute the instructions, the processor 806 may retrieve the instructions from the internal register or internal cache and decode them. During or after execution of the instructions, the processor 806 may write one or more results (which may be intermediate or final results) to the internal register or internal cache. The processor 806 may then write one or more of those results to the memory 804. In particular embodiments, the processor 806 executes only instructions in one or more internal registers or internal caches or in memory 804 (as opposed to storage 808 or elsewhere) and operates only on data in one or more internal registers or internal caches or in memory 804 (as opposed to storage 808 or elsewhere). One or more memory buses (which may each include an address bus and a data bus) may couple the processor 806 to the memory 804. The bus may include one or more memory buses, as described in further detail below. In particular embodiments, one or more memory management units (MMUs) reside between the processor 806 and memory 804 and facilitate access to the memory 804 requested by the processor 806. In particular embodiments, the memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory implementations, this disclosure contemplates any suitable memory implementation.

In particular embodiments, the storage 808 includes mass storage for data or instructions. As an example, and not by way of limitation, the storage 808 may include a hard disk drive (HDD), a floppy disk drive, flash memory, an optical disc, a magneto-optical disc, magnetic tape, or a Universal Serial Bus (USB) drive or a combination of two or more of these. The storage 808 may include removable or non-removable (or fixed) media, where appropriate. The storage 808 may be internal or external to computer system 800, where appropriate. In particular embodiments, the storage 808 is non-volatile, solid-state memory. In particular embodiments, the storage 808 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 808 taking any suitable physical form. The storage 808 may include one or more storage control units facilitating communication between processor 806 and storage 808, where appropriate. Where appropriate, the storage 808 may include one or more storages 808. Although this disclosure describes and illustrates particular storage, this disclosure contemplates any suitable storage.

In particular embodiments, the I/O Interface 810 includes hardware, software, or both, providing one or more interfaces for communication between computer system 800 and one or more I/O devices. The computer system 800 may include one or more of these I/O devices, where appropriate. One or more of these I/O devices may enable communication between a person (i.e., a user) and computer system 800. As an example, and not by way of limitation, an I/O device may include a keyboard, keypad, microphone, monitor, screen, display panel, mouse, printer, scanner, speaker, still camera, stylus, tablet, touch screen, trackball, video camera, another suitable I/O device, or a combination of two or more of these. An I/O device may include one or more sensors. Where appropriate, the I/O Interface 810 may include one or more device or software drivers enabling processor 806 to drive one or more of these I/O devices. The I/O interface 810 may include one or more I/O interfaces 810, where appropriate. Although this disclosure describes and illustrates a particular I/O interface, this disclosure contemplates any suitable I/O interface or combination of I/O interfaces.

In particular embodiments, communication interface 812 includes hardware, software, or both providing one or more interfaces for communication (such as, for example, packet-based communication) between computer system 800 and one or more other computer systems 800 or one or more networks 814. As an example, and not by way of limitation, communication interface 812 may include a network interface controller (NIC) or network adapter for communicating with an Ethernet, or any other wire-based network or a wireless NIC (WNIC) or wireless adapter for communicating with a wireless network, such as a Wi-Fi network. This disclosure contemplates any suitable network 814 and any suitable communication interface 812 for the network 814. As an example, and not by way of limitation, the network 814 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 800 may include any suitable communication interface 812 for any of these networks, where appropriate. Communication interface 812 may include one or more communication interfaces 812, where appropriate. Although this disclosure describes and illustrates a particular communication interface implementations, this disclosure contemplates any suitable communication interface implementation.

The computer system 802 may also include a bus. The bus may include hardware, software, or both and may communicatively couple the components of the computer system 800 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus, or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
receiving data for transmission and an identifier corresponding to the data;
encoding the data to form a payload;
encoding the identifier to form a training sequence;
combining the training sequence and the payload to form an audio transmission; and
transmitting the audio transmission as an audio signal within an audio environment.

2. The method of claim 1, further comprising, prior to encoding the identifier, creating a header that contains the training sequence and header information, and wherein encoding the identifier comprises encoding the header.

3. The method of claim 2, wherein the header further includes an error correction code for the training sequence and the header information.

4. The method of claim 2, wherein the header is encoded such that properly decoding the payload requires the identifier.

5. The method of claim 2, wherein the header information includes payload information necessary to accurately decode portions of the audio signal containing the payload.

6. The method of claim 5, wherein the header information includes a payload length for the payload within the audio transmission.

7. The method of claim 1, wherein the training sequence is used by a receiving computing device to equalize a received audio transmission to identify and extract data contained in the payload.

8. The method of claim 1, wherein the training sequence identifies the audio transmission within an audio environment.

9. The method of claim 1, wherein at least one of the data and the identifier are encoded with a predetermined code.

10. The method of claim 9, wherein the predetermined code is a convolution code.

11. The method of claim 10, wherein the predetermined code is a 2/3 convolution code.

12. The method of claim 1, wherein encoding the data comprises determining an error correction code for the data, and wherein both the data and the error correction code are encoded.

13. The method of claim 1, wherein the data corresponds to a request transmitted from a computing device over a network connection to a server, and wherein the server responds to the request with the identifier.

14. The method of claim 13, wherein the request includes at least one of a service request and a request to process a financial transaction.

15. A method comprising:
detecting an audio transmission within a received audio signal;
identifying a received training sequence within the audio transmission;
equalizing the audio transmission based on the received training sequence and a predetermined identifier to form an equalized audio transmission;
decoding at least a first portion of an equalized training sequence of the equalized training sequence; and
decoding a payload of the equalized audio transmission based on the decoded first portion.

16. The method of claim 15, wherein equalizing the audio transmission comprises:
generating an expected training sequence based on the predetermined identifier;
comparing the expected training sequence to the received training sequence; and
equalizing the audio transmission based on differences between symbols of the expected training sequence and the received training sequence.

17. The method of claim 16, wherein generating the expected training sequence comprises encoding the predetermined identifier according to a predetermined code and extracting a portion of the encoded predetermined identifier.

18. The method of claim 17, wherein generating the expected training sequence comprises encoding the predetermined identifier according to a predetermined code and extracting a portion of the encoded predetermined identifier.

19. The method of claim 17, further comprising generating an audio signal based on the extracted portion of the encoded predetermined identifier to serve as the expected training sequence.

20. A system comprising:
a processor; and
a memory storing instructions which, when executed, cause the processor to:
detect an audio transmission within a received audio signal;
identify a received training sequence within the audio transmission;
equalize the audio transmission based on the received training sequence and a predetermined identifier to form an equalized audio transmission;
decode at least a first portion of the received training sequence; and
decode a payload of the audio transmission based on the decoded first portion.
